(19) United States
(12) Patent Application Publication
(10) Pub. No.: US 2010/0154509 A1
(43) Pub. Date: Jun. 24, 2010

(54) METHOD FOR DETERMINING AIR FUEL RATIO OF INTERNAL COMBUSTION ENGINE ON THE BASIS OF ION CURRENT

(75) Inventors: Morito Asano, Osaka (JP); Shinobu Sugisaki, Osaka (JP); Mitsuhiro Izumi, Osaka (JP); Kouichi Kitaura, Aichi-ken (JP); Kouichi Satoya, Aichi-ken (JP); Mamoru Yoshioka, Aichi-ken (JP)

Correspondence Address: BANNER & WITCOFF, LTD., 1100 13th STREET, N.W., SUITE 1200, WASHINGTON, DC, 20005-4051, US

(73) Assignees: DAIHATSU MOTOR CO., LTD., Ikeda-shi, Osaka (JP); DIAMOND ELECTRIC MFG. CO., LTD., Osaka-shi, Osaka (JP); TOYOTA JIDOSHA KABUSHIKI KAISHA, Toyota-shi, Aichi-ken (JP)

(21) Appl. No.: 12/160,474

(22) PCT Filed: Dec. 27, 2006
(86) PCT No.: PCT/JP2006/326132

§ 371 Date: Jul. 10, 2008

(30) Foreign Application Priority Data
Jan. 10, 2006 (JP) 2006-002522

(51) Int. Cl. G01M 15/04

(52) U.S. Cl. 73/23.32

(57) ABSTRACT

In a method for determining an air fuel ratio of an internal combustion engine on the basis of an ion current, for detecting an ion current generated per ignition within a combustion chamber of the internal combustion engine, the method measures a generation period in which the ion current is greater than a determination value set as long as the ion current is generated, computes a divisor for computing a rate of fluctuation of the generation period of the ion current on the basis of a plurality of measured generation periods, computes the rate of fluctuation of the generation period of the ion current by weighing in a direction of increasing the computed divisor, and determines that an air fuel ratio is excessively high in the case that the calculated rate of fluctuation is equal to or more than a predetermined value.

### TECHNICAL FIELD

The present invention relates to a method for determining an air fuel ratio of an internal combustion engine on the basis of an ion current, which determines an air fuel ratio of the internal combustion engine mounted on a vehicle or the like, by using an ion current generated within a combustion chamber per ignition.

### BACKGROUND ART

Conventionally, in the internal combustion engine, that is, the engine mounted on the vehicle such as a motor vehicle, there is a tendency that the engine is operated in a state in which an air fuel ratio is high (a state in which an air-fuel mixture is lean) for improving a fuel consumption and purifying an exhaust gas. In the engine operated by making the air fuel ratio lean, there has been known an engine structured such that a combustion state is determined by using an ion current for making the air fuel ratio as lean as possible. For example, in the structure described in patent document 1, the structure is made such as to measure a duration of the ion current as long as the ion current generated within the combustion chamber of the engine is greater than a predetermined value after the ignition, and detect a lean limit corresponding to an air fuel ratio in a limit in which a torque fluctuation is generated, in the case that a parameter indicating a fluctuation of the measured duration exceeds a determined value.

Patent Document 1: Japanese Patent No. 3150429

In this case, in a research in recent years, it is confirmed that the parameter, for example, a rate of fluctuation indicating the fluctuation of the duration of the ion current as mentioned above becomes higher in a rich combustion state in which the air fuel ratio is low, in the same manner that the conventionally known fact that the rate of fluctuation becomes higher in the case that the air fuel ratio is lean. In other words, the ion current is generated in correspondence to the combustion state, the fluctuation of the duration is less in the case that the combustion state is good, however, since the combustion state becomes less good in comparison with the normal case, that is, the good case, the fluctuation of the duration becomes higher.

In the case that the air fuel ratio is rich, an amount of a fuel in the combustion is excessive, whereby the matter that the combustion state becomes less good is generated, in contradiction to the case that the air fuel ratio is lean. Accordingly, the duration of the ion current becomes longer because of the excessive fuel, or inversely becomes extremely short. Accordingly, the rate of fluctuation of the duration of the ion current becomes high.

As described above, since the rate of fluctuation of the duration of the ion current becomes high even in the case that the air fuel ratio is rich, in addition to the case that the air fuel ratio is lean, it is hard to determine only the case that the air fuel ratio is lean, in the structure determining the air fuel ratio on the basis of the fact that the parameter indicating the fluctuation exceeds the determined value. In other words, if the same value exists in the case that the rate of fluctuation of the duration of the ion current is lean and in the case that it is rich, it becomes hard to determine the case that the air fuel ratio is lean. On the other hand, since the rate of fluctuation of the duration of the ion current in the case of the rich air fuel ratio is lower in comparison with the case of the lean air fuel ratio, it becomes hard to determine the state in which the air fuel ratio in the case that the rate of fluctuation is low is lean, by setting the determination value high in such a manner as not to determine the case of the rich air fuel ratio as mentioned above.

### DISCLOSURE OF THE INVENTION

Accordingly, an object of the present invention is to dissolve the problem mentioned above.

In other words, in accordance with the present invention, there is provided a method for determining an air fuel ratio of an internal combustion engine on the basis of an ion current, for detecting an ion current generated per ignition within a combustion chamber of the internal combustion engine, comprising the steps of: measuring a generation period in which the ion current is greater than a determination value set as long as the ion current is generated; computing a divisor for computing a rate of fluctuation of the generation period of the ion current on the basis of a plurality of measured generation periods; computing the rate of fluctuation of the generation period of the ion current by weighing in a direction of increasing the computed divisor; and determining that an air fuel ratio is excessively high in the case that the calculated rate of fluctuation is equal to or more than a predetermined value.

The present invention utilizes a tendency that a time for which the ion current is generated becomes shorter in accordance with the higher air fuel ratio and the leaner air-fuel mixture, and an average value thereof becomes accordingly smaller in accordance with the leaner air fuel ratio. The rate of fluctuation of the generation period of the ion current is computed by dividing a deviation between the measured generation period and the average value by the divisor obtained by computing on the basis of a plurality of generation periods, and a numerical process of weighing in a direction in which the divisor is increased is carried out at a time of this computation.

The rate of fluctuation can emphasize an influence of unevenness of the generation period with respect to the divisor by numerical processing the divisor at a time of computing the rate of fluctuation of the generation period as mentioned above. In other words, the rate of fluctuation does not emphasize, which is computed by the divisor in the case of the rich air fuel ratio which is larger than the divisor in the case that the air fuel ratio is lean, by carrying out the numerical process. Accordingly, the rate of fluctuation which becomes greater than the predetermined value can be set to the rate of fluctuation in the case that the air fuel ratio is excessively lean, and it is possible to improve a precision for determining the lean of the air fuel ratio.

The present invention is structured as mentioned above, and can improve the precision for determining the lean of the air fuel ratio by emphasizing the influence of the unevenness of the generation period with respect to the divisor. Further, since it is possible to detect the operating state of the internal combustion engine in which an amount of the fuel should be increased, in an early time, by using the result of determination as mentioned above, it is possible to contribute to an improvement of an operation controllability of the internal combustion engine.

### BRIEF DESCRIPTION OF THE DRAWINGS

FIG. 1 is an explanatory view of a structure showing a schematic structure of an engine in accordance with an embodiment of the present invention.

FIG. 2 is a flow chart showing a control procedure of the embodiment.

FIG. 3 is a graph showing an ion current wave form in the case that a combustion state of the embodiment is different.

FIG. 4 is a graph showing a tendency of an average value and a rate of fluctuation with respect to an air fuel ratio of the embodiment.

### BEST MODE FOR CARRYING OUT THE INVENTION

One embodiment of the present invention will be described below with reference to the drawings.

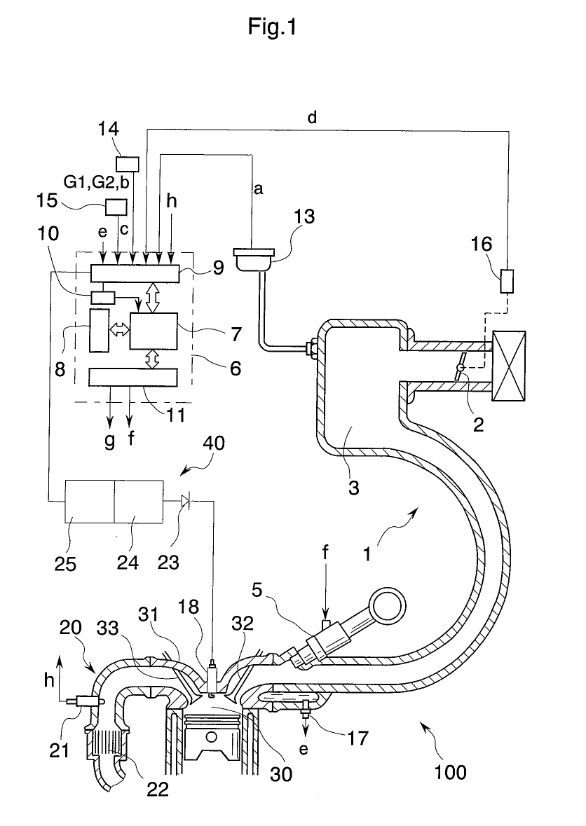

An engine 100 schematically shown in FIG. 1 is of a spark ignition type four cycle four cylinder engine for a motor vehicle, and is structured such that a throttle valve 2 opening and closing in response to an accelerator pedal (not shown) is arranged in an intake system 1, and a surge tank 3 is provided in a downstream side of the throttle valve 2. A fuel injection valve 5 is further provided near one end portion communicating with the surge tank 3, and the fuel injection valve 5 is structured such as to be controlled by an electronic control device 6. An intake valve 32 and an exhaust valve 33 are arranged in a cylinder head 31 forming a combustion chamber 30, and a spark plug 18 forming an electrode for generating a spark and detecting an ion current I is attached to the cylinder head 31. Further, an O₂ sensor 21 for measuring an oxygen concentration in the exhaust gas is attached to an upstream position of a three-way catalyst 22 corresponding to a catalyst device arranged in a pipe line until reaching a muffler (not shown), in the exhaust system 20. Here, FIG. 1 illustrates as a representative of a structure of one cylinder of the engine 100.

The electronic control device 6 is mainly constructed by a microcomputer system which includes a central processing unit 7, a memory device 8, an input interface 9, an output interface 11, and an A/D converter 10. To the input interface 9, there are input an intake pressure signal a which is output from an intake air pressure sensor 13 for detecting a pressure within the surge tank 3, that is, an intake pipe pressure, a cylinder determination signal G1, a crank angle reference position signal G2 and an engine rotating speed signal b which are output from a cam position sensor 14 for detecting a rotating state of the engine 100, a vehicle speed signal c which is output from a vehicle speed sensor 15 for detecting a vehicle speed, an IDL signal d which is output from an idle switch 16 for detecting an opened and closed state of the throttle valve 2, a water temperature signal e which is output from a water temperature sensor 17 for detecting a cooling water temperature of the engine 100, a current signal h which is output from the above O₂ sensor 21 and the like. On the other hand, a fuel ignition signal f is output to the fuel injection valve 5, and an ignition pulse g is output to a spark plug 18, from the output interface 11.

A power supply 24 for bias for measuring an ion current I is connected to the spark plug 18, and a circuit 25 for measuring the ion current is connected between the input interface 9 and the bias power supply 24. An ion current detection system 40 is constructed by the spark plug 18, the bias power supply 24 and the ion current measuring circuit 25. The bias power supply 24 is structured such as to apply a measuring voltage (a bias voltage) for measuring the ion current to the spark plug 18 at a point in time when the ignition pulse g disappears. Further, the ion current I flowing between an inner wall of the combustion chamber 30 and a center electrode of the spark plug 18, and between the electrodes of the spark plug 18, on the basis of an application of the measuring voltage is measured by the ion current measuring circuit 25. The bias power supply 24 and the ion current measuring circuit 25 can employ various structures which have been well known in the field.

In the electronic control device 6, there is installed a program for injecting the fuel in correspondence to an engine load to the intake system 1 by correcting a basic injection time (a basic injection amount) on the basis of various correction coefficients decided in correspondence to the operating state of the engine 100 by mainly using the intake air pressure signal a output from the intake air pressure sensor 13 and the rotating speed signal b output from the cam position sensor 14 so as to decide a fuel injection valve opening time, that is, an injector final exciting time T, controlling the fuel injection valve 5 on the basis of the decided exciting time. Further, the electronic control device 6 is programmed in such a manner as to control the fuel injection of the engine 100 as mentioned above, detect the ion current I generated within the combustion chamber 30 per ignition, measure the period for which the detected ion current is greater than the predetermined value, that is, the generation period of the ion current, and determine that the air fuel ratio is excessively high, that is, lean (over lean) on the basis of the rate of fluctuation of the generation period of the measured ion current.

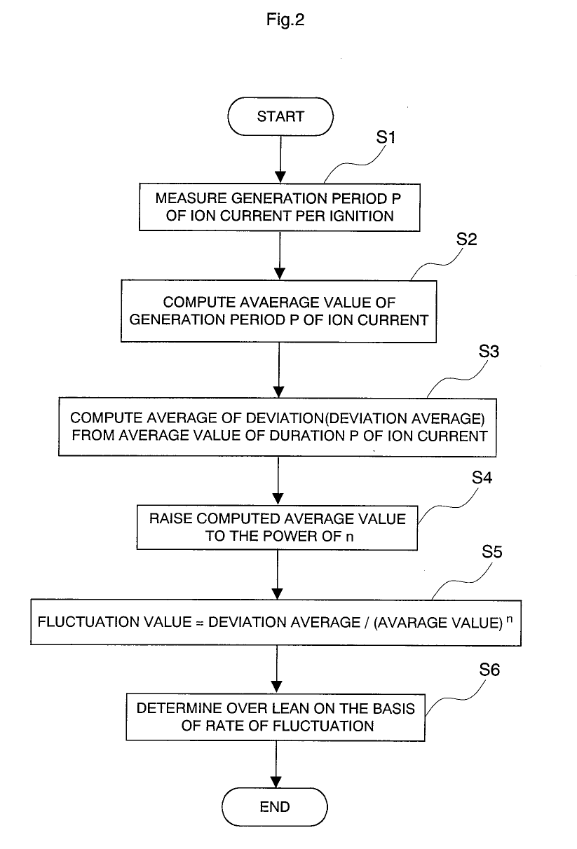

In the structure mentioned above, the air fuel ratio determining program is executed in accordance with the following procedure. FIG. 2 illustrates the procedure of determining the air fuel ratio. Here, in this air fuel ratio determining program, a threshold level SL corresponding to a determination value for measuring a generation period P for which the detected ion current I is generated is set, and a predetermined value for determining a state of the air fuel ratio from the rate of fluctuation is set. In this case, the air fuel ratio determining program may be executed by measuring the generation period P of the ion current I from the specific one cylinder, may be executed with respect to each of the cylinders, and may be executed by putting together four cylinders.

First, In a step S1, the generation period P of the ion current I per ignition is measured. The generation period P of the ion current I is measured on the basis of the time for which the ion current I is greater than the threshold level SL or a crank angle. The measured generation period P of the ion current I is temporarily stored in the memory device 8. A predetermined number (a plurality) of the stored generation periods P of the ion current I exist for computing the average value (a moving average).

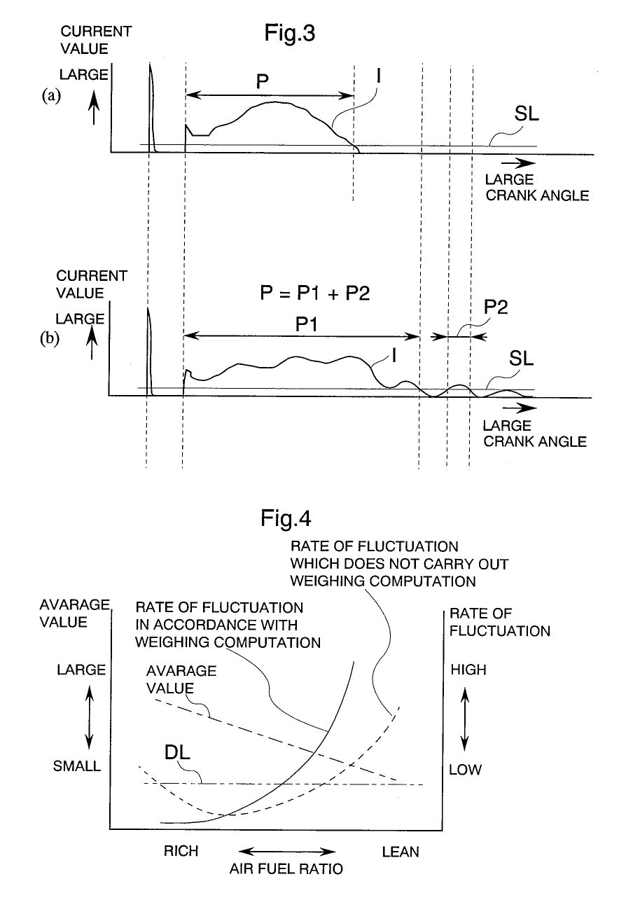

The ion current I is generated within the combustion chamber 30 by applying the measuring voltage to the spark plug 18 after the ignition. In the normal combustion state, as shown in FIG. 3(a), the ion current I rapidly flows just after the generation, is reduced before a top dead center, then, is again increased together with the elapse of the time, and the current value becomes maximum near a crank angle at which the combustion pressure becomes maximum, and is thereafter reduced little by little so as to normally disappear near an end of a expansion stroke.

In the ion current I indicating the current wave form mentioned above, the generation period P thereof is obtained by measuring the period for which the current value of the ion current I or the voltage caused by the current is greater than the threshold lever SL. In this case, the generation period P of the ion current I is measured by any one of an actual time from a start of the measurement to an end of the measurement and a crank angle. The measuring period measuring the generation period P of the ion current I is set, for example, from an ignition to an end of a expansion stroke, and the generation period P of the ion current I is set by measuring the period for which the iron current I is greater than the threshold level SL during the measuring period. It is to be noted that, the lower threshold value SL is better, however, the threshold value SL is set larger than a noise level in the case of detecting the ion current I, thereby preventing the ion current I from being erroneously detected.

The ion current I indicates various behaviors in accordance with the combustion state. For example, the behavior as mentioned above is indicated in the case of a combustion near a stoichiometric air fuel ratio, however, there is a tendency that the maximum current value becomes smaller in accordance that the air fuel ratio becomes high, that is, the air fuel ratio becomes lean, and the generation period P of the ion current I becomes shorter in accordance with an amount of the fuel. In addition, there is a tendency that the generation period P of the ion current I is elongated in accordance that the air fuel ratio becomes rich. Further, if the combustion state becomes no good due to some kind or another reason, there is a case that a disappearance and a regeneration are repeated during the measuring period in the ion current I, as shown in FIG. 3 (b). In the case mentioned above, the ion current I is generated, the periods (P1 and P2 in the case in FIG. 3 (b)) that the current value of the ion current I exceeds the threshold level SL are summed, and the sum is set to the generation period P of the ion current.

Next, in a step S2, an average value is computed on the basis of a moving average of the generation period P of a predetermined number of ion currents I including the generation period P of the ion current I which is measured at this time and is temporarily stored in the memory device 8. Since the generation period P of the ion current is changed in accordance with the air fuel ratio as mentioned above, the average value has a relation as shown in FIG. 4 with respect to the air fuel ratio. The average value is dispersed on the basis of the generation period P of the ion current I, does not come to a straight line shown by a dashed dotted line in FIG. 4, however, indicates how it is changed with respect to the change of the air fuel ratio on the basis of the dashed dotted chain line, in place of indicating the dispersion in FIG. 4. In a step S3, a deviation is computed, which is between the generation period P of the ion current I measured at this time and the average value obtained by computing, and an average (hereinafter, refer to as a deviation average) of the obtained deviations is computed.

In a step S4, the average value computed in the step S2 is raised to the power of n. This embodiment weighs in a direction of increasing the divisor by raising the average value to the power of n. In this case, at a time of weighing the average value corresponding to the divisor in the computing expression computing the rate of fluctuation as mentioned above, the average value is raised to the power of n as mentioned above in the case that the average value of the generation period P of the ion current I measured in the operating state in which the air fuel ratio is lean comes to a positive integer which is equal to or more than 1, however, if the average value comes to a numerical value less than 1, weighing is carried out by raising the average value multiplied by n.

In a step S5, the rate of fluctuation is computed in accordance with the following expression (1).

Rate of fluctuation=deviation average/(average value)ⁿ (1)

The computed rate of fluctuation becomes larger in accordance that the air fuel ratio becomes lean, as shown in FIG. 4, and becomes accordingly smaller in accordance that the air fuel ratio becomes rich. The divisor is larger in the case that the air fuel ratio is rich than in the case that the air fuel ratio is lean, for example, even if the same deviation average is obtained between the case that the air fuel ratio is rich and the case that the air fuel ratio is lean, by raising the average value to the power of n, in the computation of the rate of fluctuation in accordance with the expression (1). Therefore, the rate of fluctuation in the case that the air fuel ratio is rich becomes smaller, and the rate of fluctuation in the case that the air fuel ratio is lean is expressed in an emphasized state in accordance with a numerical process at a time if computing the rate of fluctuation.

Here, a curve shown by a dotted line in FIG. 4 does not show the rate of fluctuation in accordance with the expression (1), but shows a rate of fluctuation in the case of dividing the deviation average by the average value. In the rate of fluctuation obtained by dividing the deviation average by the average value which does not carry out the numerical process as mentioned above, there is a tendency that the rate of fluctuation becomes larger in accordance that the air fuel ratio becomes rich, and even if the air fuel ratio becomes lean, the rate of fluctuation only comes to a value which is obtained by computing in this embodiment and is lower than the rate of fluctuation.

In a step S6, it is determined that the air fuel ratio is excessively lean in the case that the rate of fluctuation obtained in the step S5 is equal to or more than a predetermined value DL. The predetermined value DL may be set on the basis of the rate of fluctuation which is determined in accordance with the experiment in the operation of the engine 100 in which the actual air fuel ratio is over lean.

With this structure, since the generation period P of the ion current I detected per ignition in each of the cylinders is measured unless the accidental fire is generated, just after starting the engine 100, the average value of the generation periods, the deviation and the deviation average are computed, the rate of fluctuation is computed in accordance with the expression (1) on the basis of the computed values, and the air fuel ratio is determined on the basis of the computed rate of fluctuation, it is possible to determine the over lean of the air fuel ratio regardless of the state of the O₂ sensor 21. In other words, if the operation of the engine 100 is started, it is possible to determine that the air fuel ratio becomes over lean even if the O₂ sensor 21 is not activated yet, for example, the cold start or the like. Accordingly, it is possible to control the fuel amount so as to increase on the basis of the result of determination in the case of determining the state in which the air fuel ratio becomes excessively lean, and it is possible to maintain a proper operating state until the rotation fluctuation, the torque fluctuation or the like is generated in the case of controlling the air fuel ratio lean.

Further, it is possible to reduce an amount of an environmental pollutant included in the exhaust gas by controlling the air fuel ratio properly. Accordingly, even in the operating state such as the start time in which the catalyst is not activated yet in the same manner as the O₂ sensor 21, it is possible to operate the engine 100 in the state in which the air fuel ratio is lean without lowering an emission of the exhaust gas.

It is to be noted that, the present invention is not limited to the embodiment mentioned above.

The rate of fluctuation of the generation period P of the ion current I may be computed by weighing the divisor in the computation in an increasing direction, in a computation of a rate of variation in statistics (quotient obtained by dividing a standard deviation by an average value). Even in this case, the weighing may employ raising the divisor to the power of n, and multiplying the divisor and n. Further, in the embodiment mentioned above, the divisor employs the average value obtained by the moving average, however, may be obtained by summing a plurality of generation periods P of the ion current I.

In addition, the particular structure of each of the portions is not limited to the embodiment mentioned above, but may be variously modified within the scope of the present invention.

### INDUSTRIAL APPLICABILITY

The present invention can be widely applied to the structure in which the ion current is generated by using the spark plug just after starting the combustion, in the spark ignition type internal combustion engine mounted on the vehicle or the like including the motor vehicle. Further, in the internal combustion engine mentioned above, it is possible to determine that the air fuel ratio is excessively lean. As a result, it is possible to maintain the internal combustion engine in the proper operating state, by detecting the operation state of the internal combustion engine to be increased the amount of the fuel in an early time.

1. A method for determining an air fuel ratio of an internal combustion engine on the basis of an ion current, for detecting an ion current generated per ignition within a combustion chamber of the internal combustion engine, comprising the steps of:
measuring a generation period in which the ion current is greater than a determination value set as long as the ion current is generated;
computing a divisor for computing a rate of fluctuation of the generation period of the ion current on the basis of a plurality of measured generation periods;
computing the rate of fluctuation of the generation period of the ion current by weighing in a direction of increasing the computed divisor; and
determining that an air fuel ratio is excessively high in the case that the calculated rate of fluctuation is equal to or more than a predetermined value.
